(19) United States
(12) Patent Application Publication
(10) Pub. No.: US 2003/0004920 A1
(43) Pub. Date: Jan. 2, 2003

(54) Method, system, and program for providing data to an application program from a file in a file system

(75) Inventors: Harriet G. Coverston, New Brighton, MN (US); Larry D. Kelley, Maple Grove, MN (US)

Correspondence Address: David W. Victor, KONRAD RAYNES & VICTOR LLP, Suite 210, 315 S. Beverly Drive, Beverly Hills, CA, 90212, US

(73) Assignee: Sun Microsystems, Inc.

(21) Appl. No.: 09/894,078

(22) Filed: Jun. 28, 2001

(51) Int. Cl. G06F 7/00

(52) U.S. Cl. 707/1

(57) ABSTRACT

Provided is a method, system, and program for managing files in a file system. A plurality of files are provided in a primary storage used by an application program. A criteria is applied to determine files to release in the primary storage that have been copied to a secondary storage. A request is received for data from the application program in one file that was released and resides on the secondary storage. Data is read from the requested file in the secondary storage into a memory accessible to the application program. Data is provided from the file in the memory to the application program before the entire file has been read from the secondary storage into the memory.

### BACKGROUND OF THE INVENTION

1. Field of the Invention

The present invention relates to a method, system, and program for providing data to an application program from a file in a file system.

2. Description of the Related Art

In hierarchical storage management (HSM) systems, files are migrated to tape storage when the data stored in disk cache reaches a certain threshold. HSM systems migrate files to tape to make room for further files being used in the system. If an application program requires data from a file migrated to tape to continue processing, then the application processing may be delayed while the entire file is staged back onto tape. Such HSM systems optimize the use of the storage space because less frequently used files may be migrated to tape and removed from the disk storage to make space available for new data, thereby increasing the effective storage capacity of the disk storage.

The delay in retrieving a migrated file from the tape storage is significant for database programs. The data in a database is stored in tables. Each database table is comprised of one or more tablespaces where the table data is stored. Each tablespace is comprised of one or more separate data files. In the prior art, all the tablespace files typically remain on the disk cache if the database tables which they comprise are open for writes by the database program. Such tablespace files remain on the disk space even if they have not been accessed for a long time. Thus, the benefits of hierarchical storage management (HSM) that would be realized by releasing old archived tablespace files cannot be realized when a substantial portion of the disk space is used to store tablespace files of an open database.

For this reason, there is a need in the art to provide improved techniques for managing files in a file system.

### SUMMARY OF THE PREFERRED EMBODIMENTS

Provided is a method, system, and program for managing files in a file system. A plurality of files are provided in a primary storage used by an application program. A criteria is applied to determine files to release in the primary storage that have been copied to a secondary storage. A request is received for data from the application program in one file that was released and resides on the secondary storage. Data is read from the requested file in the secondary storage into a memory accessible to the application program. Data is provided from the file in the memory to the application program before the entire file has been read from the secondary storage into the memory.

In further implementations, the primary storage stores a partial version of at least one released file, wherein the partial version includes a portion of the data in at least one released file.

Still further, a stage attribute is associated with each file indicating whether to stage the file transferred from the secondary storage to the memory into the primary storage. Data for the file is staged to the primary storage from the memory that was transferred from the secondary storage only if the stage attribute indicates that data from the file is to be staged.

In further implementations, groups of component files are accessed by the application program. In such case, the primary storage maintains a partial version of each released component file included in one of the groups accessed by the application program, wherein the partial version includes a portion of the released component file.

In certain implementations, the application program comprises a database program and the groups of component files comprise tablespaces that the database program has opened, wherein the component files of one opened tablespace are eligible for release according to the criteria.

### BRIEF DESCRIPTION OF THE DRAWINGS

Referring now to the drawings in which like reference numbers represent corresponding parts throughout:

FIG. 1 is an illustration of a computing environment in which aspects of the invention are implemented;

FIG. 2 illustrates a data structure for metadata in accordance with implementations of the invention;

FIGS. 3 and 4 illustrate files of a tablespace stored in the file system in accordance with implementations of the invention; and

FIGS. 5a and 5b illustrate logic to I/O requests to files in the file system in accordance with implementations of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

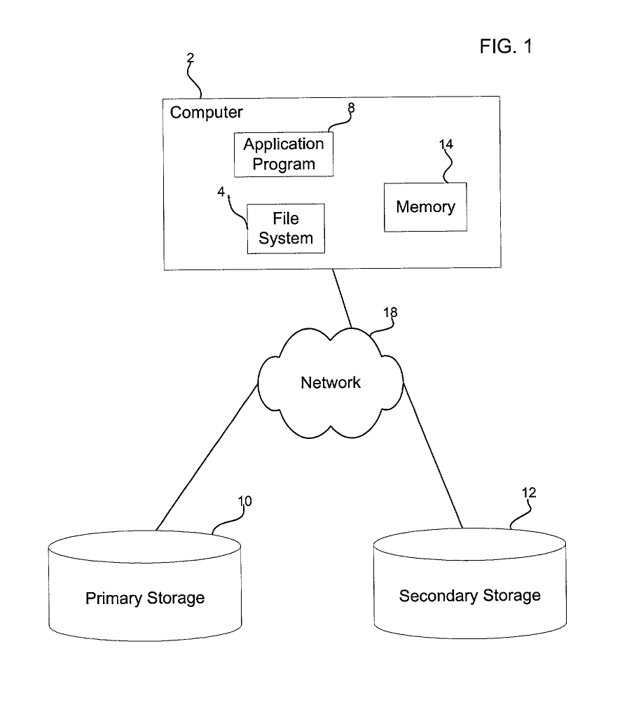

FIG. 1 illustrates a computing environment implementation of the invention. A computer 2, which may comprise any computing device known in the art, including a desktop computer, mainframe, workstation, personal computer, hand held computer, palm computer, laptop computer, telephony device, network appliance, etc., includes a file system 4 and an application program 8. The file system 4 may comprise any file system that an operating system provides to organize and manage files known in the art, such as the file system used with the Sun Microsystems Solaris operating system, Unix file system or any other file system known in the art. ** The application program 8 may comprise any application known in the art that creates and accesses data files in the file system 4, such as a database program, word processing program, software development tool or any other application program known in the art. A network 18, which may comprise any network system known in the art, such as Fibre Channel, Local Area Network (LAN), an Intranet, Wide Area Network (WAN), Storage Area Network (SAN), etc., enables communication between the computer 2, primary storage 10, and secondary storage 12. Alternatively, the computer 2 may be connected to the disk cache 10 and tape library 12 via direct transmission lines or cables (not shown). Data transferred between the primary storage, such as a disk cache, 10 and the secondary storage 12, such as a tape library, transferred through the file system 4 in the computer 2 or, alternatively, directly between the primary storage 10 and secondary storage 12 via the network 18 or a direct transmission line (not shown). SOLARIS is a trademark of Sun Microsystems, Inc.; UNIX is a registered trademark of The Open Group; SAM-FS is a trademark of LSC, Inc.

In the described implementations, the file system 4 further includes programs for managing the storage of files in the file system 4 in a primary storage 10 and secondary storage 12. In certain implementations, the primary storage 10 comprises a disk cache or group of interconnected hard disk drives that implement a single storage space. The applications 8 process data stored in the primary storage 10. The secondary storage 12 is used for maintaining a backup copy of files in the file system 4 and for expanding the overall available storage space. In certain implementations, the secondary storage 12 comprises a slower access and less expensive storage system than the primary storage 12. For instance, the secondary storage 12 may comprise a tape library including one or more tape drives and numerous tape cartridges, an optical library, slower and less expensive disk drives, etc. In certain implementations, once a tape cartridge is mounted in a tape drive, data may be transferred between the primary 10 and secondary 12 storage.

In certain implementations, the file system 4 is capable of performing Hierarchical Storage Management (HSM) related functions, such as automatically archiving files in the primary storage 10 in the secondary storage 12. Files are archived when they meet a set of archive criteria, such as age, file size, time last accessed, etc. The file system 4 may also perform staging operations to copy data archived on the secondary storage 12 to the primary storage 10 to make available to the applications 8. The file system 4 may also perform release operations to free space in the primary storage 10 used by files archived to the secondary storage 12 in order to make more space available for more recent data. In certain implementations, the release operation may utilize high and low thresholds. When the used space in the primary storage 10 reaches a high threshold, the file system 4 releases files in the primary storage 10 that have been archived to secondary storage. The primary storage 10 space used by the released file is available for use to store other data. In certain implementations, the file system 4 stops releasing files when the used storage space is at the low threshold level. Further details of the HSM capabilities that may be included in the file system 4 are described in the LSC, Inc. publication entitled “SAM-FS System Administrator's Guide”, LSC, Inc. publication no. SG-0001, Revision 3.5.0 (1995, July, 2000) and the archiving file system described in U.S. Pat. No. 5,764,972, which publication and patent are incorporated herein by reference in its entirety.

The computer 2 further includes a memory 14, which may comprise any volatile memory device known in the art for buffering data and program code currently being executed. For instance, the application program 8 would read data from the primary storage 10 into the memory 14 to access and utilize.

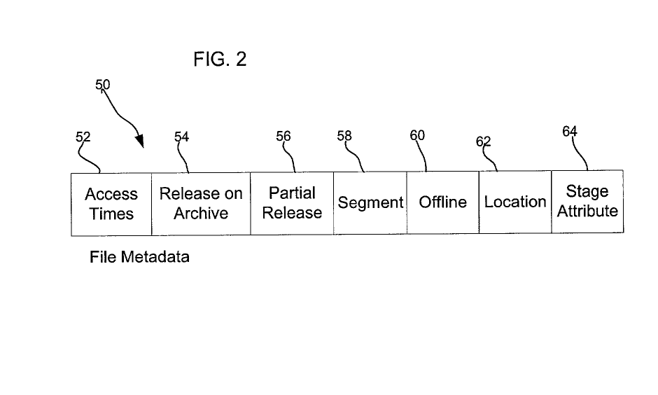

In the described implementations, the file system 4 maintains metadata for each file represented in the file system 4. For instance, in Unix type operating systems, a data structure referred to as the i-node maintains the file metadata. Other operating systems may maintain metadata in different formats. FIG. 2 illustrates information fields maintained in file metadata 50, which is maintained for each file and directory in the file system 4. Below are some of the information fields that may be maintained in the file metadata 50 for files and directories in the file system 4:

Access Times 52: the time the file was last accessed, modified, created, etc.

Release on Archive 54: indicates that once one or more archive copies of the file are made in the secondary storage 12, the file may be subject to an immediate or delayed release operation.

Partial Release 56: indicates that the first n bytes of the file are maintained in the primary storage 10 after the release operation, where n may be a user settable parameter.

Segment 58: indicates that the file data is stored in separate segments as described in the copending and commonly assigned patent application entitled “Method, System, and Program for Managing Files in a File System,” having attorney docket no. P6433 filed on the same date herewith, which patent application is incorporated herein by reference in its entirety.

Offline 60: indicates that the file is currently resident in the secondary storage 12 and not in the primary storage 10.

Location 62: indicates the location of the file, which may comprise an address in the primary storage and/or secondary storage, such as the disk or tape volume and block address therein.

Stage Never Attribute 64: Comprises an attribute for the staging operation from the secondary storage 12 to the primary storage 10 for a file. The stage never attribute 64 indicates whether data transferred from the secondary storage 12 to the memory 14 for a particular file is to be destaged to the primary storage 10. If the stage attribute is set, then the data is read from the secondary storage into the memory 14 used by the application program 8 to buffer data and not staged to the primary storage 10, thereby not affecting the storage of other files in the primary storage. If the stage attribute not set, then the file is staged from the secondary storage 12 to memory 14, and then destaged from memory 14 to primary storage 10 according to the memory 14 caching algorithms. When the stage never attribute 64 is set, a window of data is staged into memory 14. The size of the window can be set by the user. If the file size is small, such as small database records, e.g., credit card transactions or other On-Line Transaction Processing (OLTP), then the user may set a small window size. If transferring large files, such as during a sequential access, then the window may be large.

Further types of file metadata that may be included with the file metadata 50 are described in U.S. Pat. No. 5,764,972, which was incorporated by reference above.

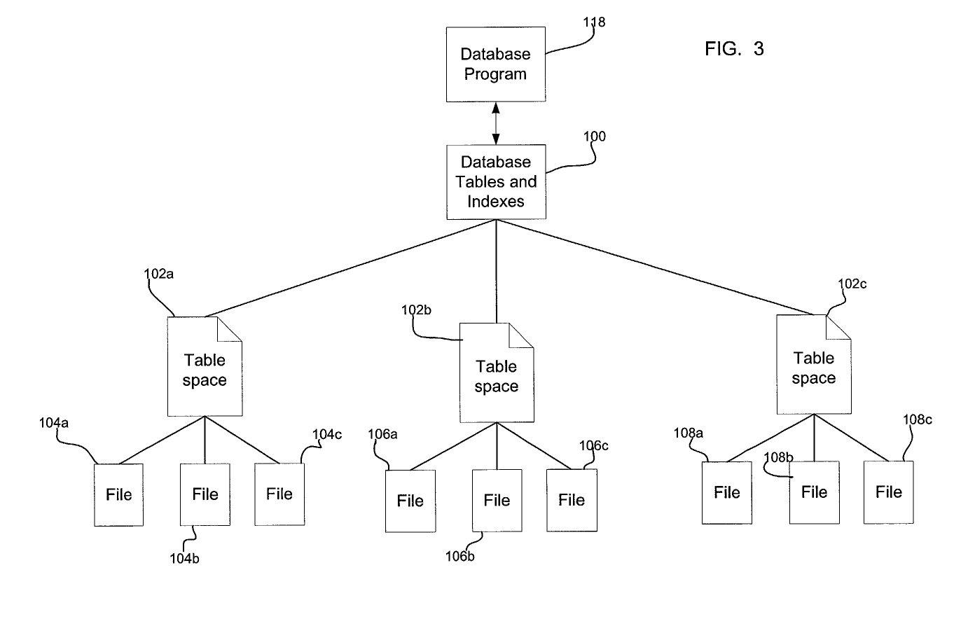

FIG. 3 illustrates how database tables and indexes 100 accessed by a database program 118 are comprised of multiple tablespaces 102a, b, c, wherein each tablespace 102a, b, c is comprised of multiple component data files 104a, b, c, 106a, b, c, and 108a, b, c that store the database data, such as database records.

In implementing the HSM features, the file system 4 would archive and release the files 104a, b, c, 106a, b, c, and 108a, b, c using the same criteria that is applied to determine regular files to release in the file system. Moreover the tablespace files 104a, b, c, 106a, b, c, and 108a, b, c may be archived and released at different times, thereby leaving less than all the tablespace files in the primary storage 10. For instance, a more recently accessed tablespace file 104a, b, c, 106a, b, c, and 108a, b, c may remain in the primary storage 10 while a tablespace file that is one of the least recently used files may be marked for release.

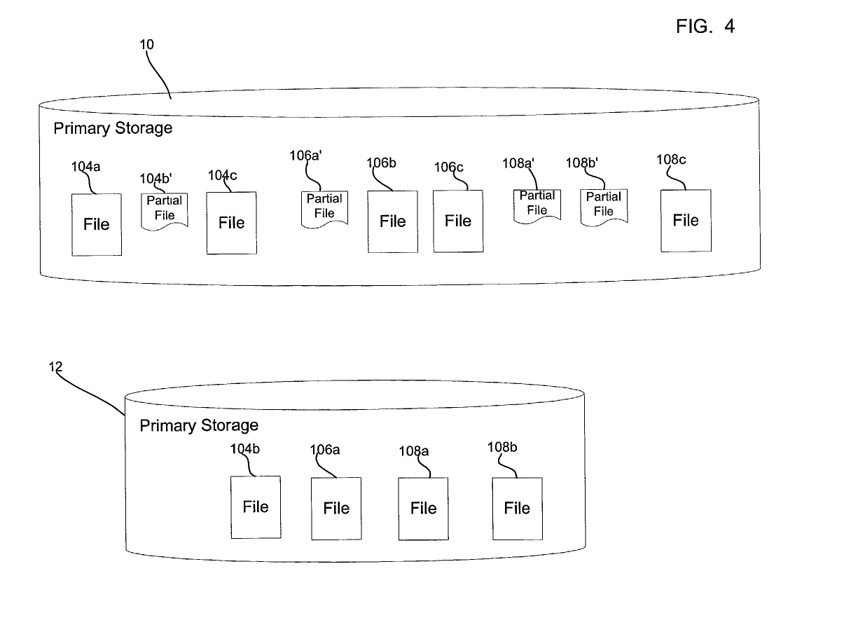

In certain implementations, the partial release field 56 in the metadata 50 for each tablespace file would indicate a partial release, such that when the tablespace files 104a, b, c, 106a, b, c, and 108a, b, c are released a partial version of the tablespace file remains in the primary storage 10 that includes a first n bytes of the table space file, e.g., where n may be a predetermined or user specified number of bytes. FIG. 4 illustrates that the primary storage 10 includes both complete tablespace files 104a, b, 106b, c, and 108c as well as partial versions 104c′, 106a′, 108a′, and 108b′ of certain files that have been archived in the secondary storage and released. For any file 104c, 106a, 108a, b released and having a partial version 104c′, 106a′, 108a′, and 108b′ remaining on the primary storage 10, one or more copies the full version of the file 104c, 106a, 108a, b are archived on secondary storage as shown in FIG. 4.

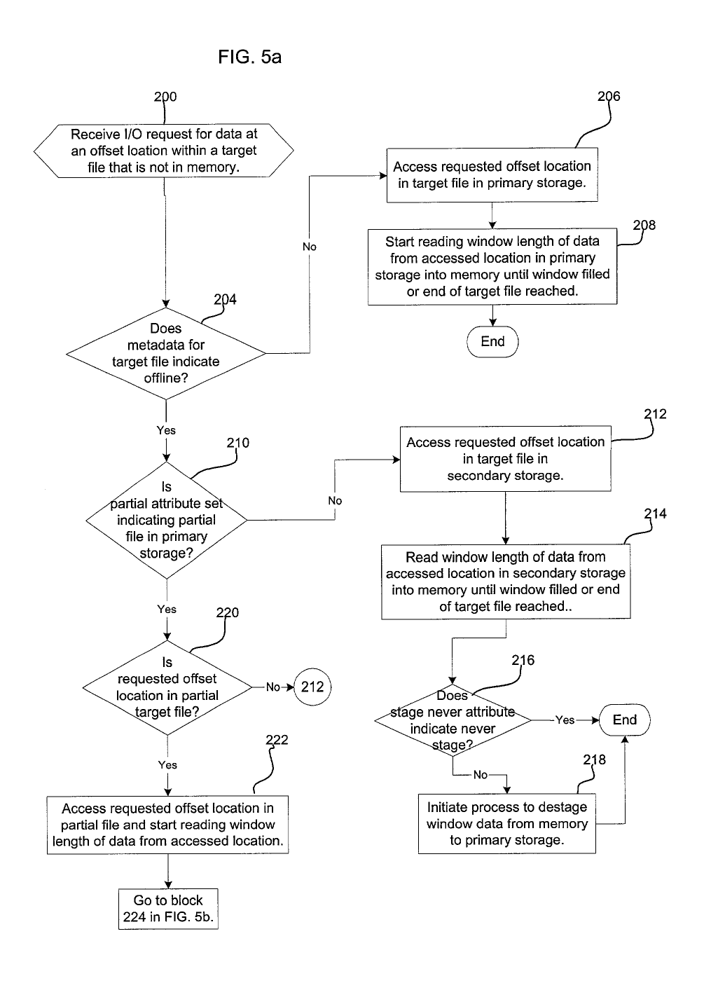

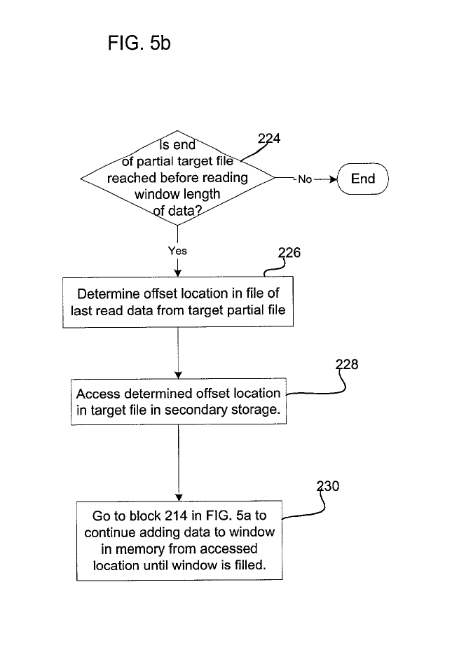

FIGS. 5a, b illustrate logic implemented in the file system 4 to process an Input/Output (I/O) request, i.e., read or write, to a file, such as the tablespace files 104a, b, c, 106a, b, c, and 108a, b, c, in response to a read request received at block 200 from an application program 8, such as the database program 118 that reads data from the memory 14. The logic of FIGS. 5a, b is invoked if the requested data at the offset location in the file is not in the memory 14. Otherwise, if the requested data is in the memory 14, then the data may be accessed directly from memory 14. If (at block 202) the metadata 50 for the file indicates that the target file is in the primary storage 10, which is indicated by the offline field 60 (FIG. 2) being set to “off”, then the file system 4 accesses (at block 206) the requested offset location within the target file and reads (at block 208) a window length of data from the accessed location in the primary storage 10 until the window is filled in memory 14 or the end of the target file is reached. The window length may comprise a predefined or user specified amount of data that is read and stored in memory 14.

If (at block 204) the target file is offline and if (at block 210) the partial release attribute 56 (FIG. 2) is “off” (indicating that no partial version of the file is in the primary storage 10), then the file system 4 accesses (at block 212) the determined offset location in the target file in secondary storage 12 and reads (at block 214) the window length of data from the accessed location in the secondary storage 12 until the window is filled in memory 14 or the end of the target file is reached. After reading the window of data from the secondary storage 12 into memory 14, the file system 4 determines (at block 216) whether the stage never attribute 64 indicates that the data is not to be staged from the memory 14 to the primary storage 10. If the stage never attribute 64 indicates that data is not to be staged, then no action is taken to stage the data from the memory 14 to primary storage 10; otherwise, if the stage never attribute 64 indicates that data is to be staged, then the file system 4 would initiate action (at block 218) to stage the window of data in memory 14 to primary storage 10. In further implementations, the file system 4 may inhibit the staging of data to the primary storage 10 if the stage never attribute 64 indicates that data is not to be staged in alternative manners, such as by controlling the memory 14 manager.

If (at block 210) a partial version of the target file is in the primary storage 10, i.e., the first n bytes of the file are maintained on the primary storage 10, then the file system 4 determines (at block 220) whether the requested offset location is in the partial target file on the primary storage 10, i.e., within the first n bytes of the target file maintained in the partial target file. If not, control proceeds to block 212 to access the window of data at the offset location from the secondary storage 12. Otherwise, if the requested offset location is within the partial target file, then the file system 4 accesses (at block 222) the requested offset location in the partial file and reads the window length of data from the accessed location in the partial file. At block 224 in FIG. 5b, if the entire window length of data is read before reaching the end of the partial target file, then control ends; otherwise, the file system 4 determines (at block 226) the offset location in the target file on secondary storage 12 of the last read data at the end of the target partial file. The file system 4 then accesses (at block 228) the determined offset location of the target file in the secondary storage 12 and proceeds (at block 230) back to block 214 in FIG. 5a to continue reading data into the window in memory 14 from the secondary storage 12 until the window is filled or the end of the target file on secondary storage 12 is reached.

In further implementations, data being read into the window is immediately loaded into the memory 14 where it is available to application programs, such as the database program 118, even before the entire window has been filled. This feature allows the application program to obtain immediate access to data once the data is read into memory 14.

Still further, in performing an I/O request, the file system 4 may read multiple windows of data into memory 14 at a time, thereby prestaging data that may be requested. The number of windows of data to stage at a time in response to an I/O request may be a user settable parameter.

In implementations, where the application requesting data in files comprises a database program 118 requesting tablespace data in tablespace files 104a, b, c, 106a, b, c, and 108a, b, c, the tablespace file data read from the secondary storage 12 is transferred to the area of memory 14 used by the database program 118. In this way, performance of the database program 118 is improved because data is made available to the database program 118 in memory 14 before the entire tablespace file 104a, b, c, 106a, b, c, and 108a, b, c is staged into primary storage 10. With the described implementations, data is provided directly from the secondary storage 12 to memory 14 and immediately made available in memory 14 to the database program 118.

Moreover, in implementations where the data transferred to memory 14 is not staged into the primary storage 10, providing the tablespace data to the database program 118 from the secondary storage 12 does not consume the primary storage 10 space and cause the file system 4 to release active data on the primary storage 10.

Further, in database implementations, the tablespace files 104a, b, c, 106a, b, c, and 108a, b, c may be released and a partial tablespace file 104b′, 106a′, 108a′, 108b (FIG. 4) left on the primary storage 10 even while the tablespace 102a, b, c is in an open state, i.e., available to receive writes from the database program 118. This process of releasing tablespace files, including open tablespace files, according to migration criteria and leaving a partial tablespace file on primary storage 10 frees primary storage 10 space for more frequently accessed data from other applications or further tablespace files. Moreover, the described implementations provide fast access to tablespace files on the secondary storage by transferring windows of data to the memory to make data immediately available to the database program 118 before the entire tablespace file is staged.

Additional Implementation Details

The technique for managing data in a file system may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments of the configuration discovery tool are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In the illustrations, a certain number of devices were shown. For instance, FIG. 1 illustrates one primary 10 and secondary 12 storage device. However, additional or fewer devices than shown may be used, e.g., more or less tape cartridges and tape drives may be included in the secondary storage 12. Further, the primary 10 and secondary 12 storage may be comprised of multiple storage devices and systems.

The described file management operations were are performed by the file system component of an operating system. In alternative implementations, certain of the operations described as performed by the file system may be performed by some other program executing in the computer 2, such as an application program or middleware.

In certain described implementations, the files that were represented as partial files and read into the memory 14 from secondary storage 12 comprised tablespace files 104a, b, c, 106a, b, c, and 108a, b, c. Additionally, the above described technique for making tablespace data available to a database program 118 without having to stage in the entire data file is applicable to any data files used by any application program, and is not just limited to database programs.

In the described implementations, the primary storage 10 comprised a faster access storage than the secondary storage, and the storage media were different. Alternatively, the primary storage 10 and secondary storage 12 may have the same access speeds and be implemented on the same storage media. Still further, the described file management technique may be used for files stored in one storage device that are not archived on a secondary storage.

The program flow logic described in the flowcharts indicated certain events occurring in a certain order. Those skilled in the art will recognize that the ordering of certain programming steps or program flow may be modified without affecting the overall operation performed by the preferred embodiment logic, and such modifications are in accordance with the preferred embodiments.

The described implementations were discussed with respect to a Unix based operating systems. However, the described implementations may apply to any operating system that provides file metadata and allows files in the system to be associated with different groups of users.

The described implementations may apply to situations where an application program accesses data maintained in multiple files.

In the described implementations, file information, such as the stage attributes and other file attributes was maintained in file metadata used by the file system. Alternatively, the file attribute information may be maintained in data structures and tables other than the file metadata used by the file system.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing files in a file system, wherein an application program accesses files in the file system, comprising:
providing a plurality of files in a primary storage used by the application program;
applying a criteria to determine files to release in the primary storage that have been copied to a secondary storage;
receiving a request for data from the application program in one file that was released and resides on the secondary storage;
reading the data from the file in the secondary storage into a memory accessible to the application program; and
providing data from the file in the memory to the application program before the entire file has been read from the secondary storage into the memory.

2. The method of claim 1, further comprising:
storing in the primary storage a partial version of at least one released file, wherein the partial version includes a portion of the data in at least one released file.

3. The method of claim 2, wherein the partial version of the file comprises a first number of bytes of the released file that is less than all the bytes in the file, further comprising:
receiving user input indicating the first number of bytes included in the partial version of the file.

4. The method of claim 2, wherein an attribute is provided for each file indicating whether the partial version of the file is maintained in the primary storage after the file is released, wherein the partial version is only maintained in the primary storage for those released files having the attribute indicating that the partial version is to be maintained.

5. The method of claim 2, wherein the requested data is in the partial version, further comprising:
reading the data from the partial version of the file in the primary storage into the memory to make available to the application program.

6. The method of claim 5, further comprising:
receiving a further request from the application program for data in the file that is not included in the partial version of the file; and
determining a location in the file in the secondary storage of the further requested data, wherein reading the data from the file in the secondary storage comprises reading data from the determined location in the file in the secondary storage into the memory to make available to the application program.

7. The method of claim 6 wherein data is read from the file in the secondary storage in a fixed byte length window, and wherein reading the further requested data from the determined location in the file in the secondary storage further comprises:
reading enough data to fill the fixed length byte window by reading data from the partial version and the further requested data read from the determined location in the secondary storage, wherein the window of the data is transferred to the memory.

8. The method of claim 1, wherein data is read from the file in the secondary storage in a fixed byte length window.

9. The method of claim 8, wherein multiple windows of data are read from the file in the secondary storage into the memory in response to the data request.

10. The method of claim 8, further comprising:
receiving a request for data from the file that follows the data transferred into the memory; and
reading at least one window of further data having the fixed byte length from the file in the secondary storage into the memory to make available to the application program.

11. The method of claim 8, wherein reading the data into the window further comprises:
storing the data read into the window in the memory; and
making the data from the window read into the memory available to the application program before the entire window of data is read into the memory.

12. The method of claim 8, further comprising:
receiving user input indicating a size of the fixed byte length of the window.

13. The method of claim 1, wherein a stage attribute is associated with each file indicating whether to stage the file transferred from the secondary storage to the memory into the primary storage, comprising:
staging data to the primary storage from the memory that was transferred from the secondary storage only if the stage attribute indicates that data from the file is to be staged.

14. The method of claim 1, wherein the files include component files of groups that are accessed by the application program, further comprising:
storing in the primary storage a partial version of each released component file included in one of the groups accessed by the application program, wherein the partial version includes a portion of the released component file.

15. The method of claim 14, wherein the component files are capable of being stored in both the primary and secondary storages.

16. The method of claim 14, wherein component files capable of being released and replaced by the partial version are included in groups that are open to the application program.

17. The method of claim 14, wherein the application program comprises a database program and wherein the groups of component files comprise tablespaces that the database program has opened, and wherein the component files of one opened tablespace are eligible for release according to the criteria.

18. The method of claim 17, wherein at least one component file of one tablespace is stored in the primary storage and the partial version of at least one released component file of the tablespace is stored in the primary storage.

19. A system for managing files in a file system, wherein an application program accesses files in the file system, comprising:
a primary storage including a plurality of files used by the application program;
a secondary storage maintaining copies of files in the primary storage;
a computer readable medium accessible to the application program;
means for applying a criteria to determine files to release in the primary storage that have been copied to the secondary storage;
means for receiving a request for data from the application program in one file that was released and resides on the secondary storage;
means for reading the data from the file in the secondary storage into the computer readable medium accessible to the application program; and
means for providing data from the file in the computer readable medium to the application program before the entire file has been read from the secondary storage into the computer readable medium.

20. The system of claim 19, further comprising:
means for storing in the primary storage a partial version of at least one released file, wherein the partial version includes a portion of the data in at least one released file.

21. The system of claim 20, wherein the partial version of the file comprises a first number of bytes of the released file that is less than all the bytes in the file, further comprising:
means for receiving user input indicating the first number of bytes included in the partial version of the file.

22. The system of claim 20, wherein an attribute is provided for each file indicating whether the partial version of the file is maintained in the primary storage after the file is released, wherein the partial version is only maintained in the primary storage for those released files having the attribute indicating that the partial version is to be maintained.

23. The system of claim 20, wherein the requested data is in the partial version, further comprising:
means for reading the data from the partial version of the file in the primary storage into the computer readable medium to make available to the application program.

24. The system of claim 23, further comprising:
means for receiving a further request from the application program for data in the file that is not included in the partial version of the file; and
means for determining a location in the file in the secondary storage of the further requested data, wherein the means for reading the data from the file in the secondary storage reads data from the determined location in the file in the secondary storage into the computer readable medium to make available to the application program.

25. The system of claim 24, wherein data is read from the file in the secondary storage in a fixed byte length window, and wherein the means for reading the further requested data from the determined location in the file in the secondary storage further performs:
reading enough data to fill the fixed length byte window by reading data from the partial version and the further requested data read from the determined location in the secondary storage, wherein the window of the data is transferred to the computer readable medium.

26. The system of claim 19, wherein data is read from the file in the secondary storage in a fixed byte length window.

27. The system of claim 26, wherein multiple windows of data are read from the file in the secondary storage into the computer readable medium in response to the data request.

28. The system of claim 26, further comprising:
means for receiving a request for data from the file that follows the data transferred into the computer readable medium; and
means for reading at least one window of further data having the fixed byte length from the file in the secondary storage into the computer readable medium to make available to the application program.

29. The system of claim 26, wherein the means for reading the data into the window further performs:
storing the data read into the window in the computer readable medium; and
making the data from the window read into the computer readable medium available to the application program before the entire window of data is read into the computer readable medium.

30. The system of claim 26, further comprising:
means for receiving user input indicating a size of the fixed byte length of the window.

31. The system of claim 19, wherein a stage attribute is associated with each file indicating whether to stage the file transferred from the secondary storage to the computer readable medium into the primary storage, further comprising:
means for staging data to the primary storage from the computer readable medium that was transferred from the secondary storage only if the stage attribute indicates that data from the file is to be staged.

32. The system of claim 19, wherein the files include component files of groups that are accessed by the application program, further comprising:
means for storing in the primary storage a partial version of each released component file included in one of the groups accessed by the application program, wherein the partial version includes a portion of the released component file.

33. The system of claim 32, wherein the component files are capable of being stored in both the primary and secondary storages.

34. The system of claim 32, wherein component files capable of being released and replaced by the partial version are included in groups that are open to the application program.

35. The system of claim 32, wherein the application program comprises a database program and wherein the groups of component files comprise tablespaces that the database program has opened, and wherein the component files of one opened tablespace are eligible for release according to the criteria.

36. The system of claim 35, wherein at least one component file of one tablespace is stored in the primary storage and the partial version of at least one released component file of the tablespace is stored in the primary storage.

37. An article of manufacture including code for managing files in a file system, wherein an application program accesses files in the file system by:
providing a plurality of files in a primary storage used by the application program;
applying a criteria to determine files to release in the primary storage that have been copied to a secondary storage;
receiving a request for data from the application program in one file that was released and resides on the secondary storage;
reading the data from the file in the secondary storage into a memory accessible to the application program; and
providing data from the file in the memory to the application program before the entire file has been read from the secondary storage into the memory.

38. The article of manufacture of claim 37, further comprising:
storing in the primary storage a partial version of at least one released file, wherein the partial version includes a portion of the data in at least one released file.

39. The article of manufacture of claim 38, wherein the partial version of the file comprises a first number of bytes of the released file that is less than all the bytes in the file, further comprising:
receiving user input indicating the first number of bytes included in the partial version of the file.

40. The article of manufacture of claim 38, wherein an attribute is provided for each file indicating whether the partial version of the file is maintained in the primary storage after the file is released, wherein the partial version is only maintained in the primary storage for those released files having the attribute indicating that the partial version is to be maintained.

41. The article of manufacture of claim 38, wherein the requested data is in the partial version, further comprising:
reading the data from the partial version of the file in the primary storage into the memory to make available to the application program.

42. The article of manufacture of claim 41, further comprising:
receiving a further request from the application program for data in the file that is not included in the partial version of the file; and
determining a location in the file in the secondary storage of the further requested data, wherein reading the data from the file in the secondary storage comprises reading data from the determined location in the file in the secondary storage into the memory to make available to the application program.

43. The article of manufacture of claim 42, wherein data is read from the file in the secondary storage in a fixed byte length window, and wherein reading the further requested data from the determined location in the file in the secondary storage further comprises:
reading enough data to fill the fixed length byte window by reading data from the partial version and the further requested data read from the determined location in the secondary storage, wherein the window of the data is transferred to the memory.

44. The article of manufacture of claim 37, wherein data is read from the file in the secondary storage in a fixed byte length window.

45. The article of manufacture of claim 44, wherein multiple windows of data are read from the file in the secondary storage into the memory in response to the data request.

46. The article of manufacture of claim 44, further comprising:
receiving a request for data from the file that follows the data transferred into the memory; and
reading at least one window of further data having the fixed byte length from the file in the secondary storage into the memory to make available to the application program.

47. The article of manufacture of claim 44, wherein reading the data into the window further comprises:
storing the data read into the window in the memory; and
making the data from the window read into the memory available to the application program before the entire window of data is read into the memory.

48. The article of manufacture of claim 44, further comprising:
receiving user input indicating a size of the fixed byte length of the window.

49. The article of manufacture of claim 37, wherein a stage attribute is associated with each file indicating whether to stage the file transferred from the secondary storage to the memory into the primary storage, comprising:
staging data to the primary storage from the memory that was transferred from the secondary storage only if the stage attribute indicates that data from the file is to be staged.

50. The article of manufacture of claim 37, wherein the files include component files of groups that are accessed by the application program, further comprising:
storing in the primary storage a partial version of each released component file included in one of the groups accessed by the application program, wherein the partial version includes a portion of the released component file.

51. The article of manufacture of claim 50, wherein the component files are capable of being stored in both the primary and secondary storages.

52. The article of manufacture of claim 50, wherein component files capable of being released and replaced by the partial version are included in groups that are open to the application program.

53. The article of manufacture of claim 50, wherein the application program comprises a database program and wherein the groups of component files comprise tablespaces that the database program has opened, and wherein the component files of one opened tablespace are eligible for release according to the criteria.

54. The article of manufacture of claim 53, wherein at least one component file of one tablespace is stored in the primary storage and the partial version of at least one released component file of the tablespace is stored in the primary storage.
